(19) United States
(12) Patent Application Publication
(10) Pub. No.: US 2024/0400063 A1
(43) Pub. Date: Dec. 5, 2024

(54) CONTROL DEVICE

(71) Applicant: TOYOTA JIDOSHA KABUSHIKI KAISHA, Toyota-shi (JP)

(72) Inventors: Keigo IKEDA, Nisshin-shi (JP); Yasuhiro SAITO, Toyoake-shi (JP); Daiki YOKOYAMA, Miyoshi-shi (JP)

(73) Assignee: TOYOTA JIDOSHA KABUSHIKI KAISHA, Toyota-shi (JP)

(21) Appl. No.: 18/659,774

(22) Filed: May 9, 2024

(30) Foreign Application Priority Data
May 31, 2023 (JP) 2023-089448
Oct. 23, 2023 (JP) 2023-181749

(51) Int. Cl. B60W 40/12; B60W 50/00

(52) U.S. Cl. CPC B60W 40/12; B60W 2050/0004; B60W 2556/50; B60W 2756/00

(57) ABSTRACT

A control device is configured to generate a control command for controlling a movable body, using measurement results of a plurality of distance measurement devices. The control device includes a point cloud combining unit configured to create combined point cloud data by combining two or more pieces of three-dimensional point cloud data that are obtained by two or more distance measurement devices of the plurality of distance measurement devices. The control device is configured to execute a first estimation process of estimating at least one of the position and orientation of the movable body, using the combined point cloud data.

### CROSS-REFERENCE TO RELATED APPLICATION

This application claims priority to Japanese Patent Application No. 2023-089448 filed on May 31, 2023 and Japanese Patent Application No. 2023-181749 filed on Oct. 23, 2023, each incorporated herein by reference in its entirety.

### BACKGROUND

### 1. Technical Field

The present disclosure relates to a control device of a movable body.

### 2. Description of Related Art

There is known a technology in which self-traveling conveyance of a vehicle is performed in the manufacturing process of the vehicle (Japanese Unexamined Patent Application Publication (Translation of PCT application) No. 2017-538619).

### SUMMARY

When a movable body such as a vehicle is moved by self-traveling conveyance, a process of estimating the position and orientation of the movable body is executed. The position and orientation of the movable body can be estimated using three-dimensional point cloud data that is acquired using a distance measurement device such as a camera and a radar. In the estimation process, a short-cycle calculation is necessary for the stabilization of the traveling control for the movable body. However, in JP 2017-538619 A, contrivance is not sufficiently performed for enhancing the estimation accuracy for the position and orientation of the movable body. Further, in the estimation of the position and orientation of the movable body, the estimation accuracy and the processing speed have a trade-off relation, and therefore it is desirable to give priority to one of the estimation accuracy and the processing speed depending on the situation.

The present disclosure provides a control device that enhances the estimation accuracy for the position and orientation of the movable body.

A control device according to a first aspect of the present disclosure is configured to generate a control command for controlling a movable body, using measurement results of a plurality of distance measurement devices. The control device includes a point cloud combining unit configured to create combined point cloud data by combining two or more pieces of three-dimensional point cloud data that are obtained by two or more distance measurement devices of the plurality of distance measurement devices. The control device includes an estimation unit configured to execute a first estimation process of estimating at least one of the position and orientation of the movable body, using the combined point cloud data.

With this control device, since the combined point cloud data resulting from combining two or more pieces of three-dimensional point cloud data is used, it is possible to enhance the estimation accuracy for the position and orientation of the movable body.

In the control device according to the first aspect of the present disclosure, the estimation unit may be configured to execute the first estimation process, when an allowable processing time for the estimation process is equal to or longer than a time reference value.

With this control device, it is possible to enhance the estimation accuracy using the combined point cloud data, when the allowable processing time for the first estimation process is long.

In the control device according to the first aspect of the present disclosure, the estimation unit may be configured to execute a second estimation process of estimating at least one of the position and orientation of the movable body, using a single piece of the three-dimensional point cloud data, when the allowable processing time is shorter than the time reference value.

With this control device, it is possible to enhance the processing speed using a single piece of three-dimensional point cloud data, when the allowable processing time for the estimation process is short.

In the control device according to the first aspect of the present disclosure, the estimation unit may be configured to execute the first estimation process, when a required accuracy of the control of the movable body is equal to or higher than an accuracy reference value.

With this control device, it is possible to enhance the estimation accuracy using the combined point cloud data, when the required accuracy of the control of the movable body is high.

In the control device according to the first aspect of the present disclosure, the estimation unit may be configured to select and execute one of the first estimation process and a second estimation process of estimating at least one of the position and orientation of the movable body, using a single piece of the three-dimensional point cloud data, depending on a traveling situation of the movable body.

With this control device, it is possible to give priority to one of the estimation accuracy and the processing speed, depending on the traveling situation of the movable body.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a conceptual diagram showing the configuration of a remote control system in an embodiment;

FIG. 2 is a block diagram showing the configuration of a vehicle and a remote control device in a first embodiment;

FIG. 3 is a flowchart showing a processing procedure of a remote control in the first embodiment;

FIG. 4 is an explanatory diagram showing an example of alteration of the number of pieces of three-dimensional point cloud data that are used;

FIG. 5 is a block diagram showing the configuration of a vehicle and a remote control device in a second embodiment; and

FIG. 6 is a flowchart showing a processing procedure of a vehicle control in the second embodiment.

### DETAILED DESCRIPTION OF EMBODIMENTS

### A. First Embodiment

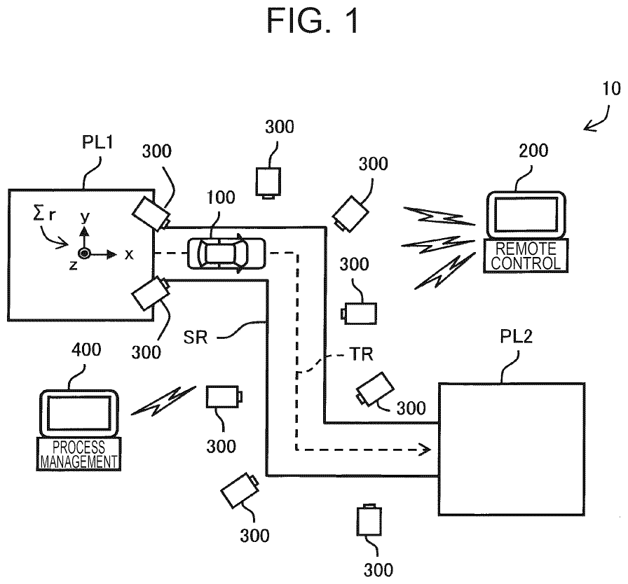

FIG. 1 is a conceptual diagram showing the configuration of a remote control system 10 in an embodiment. A remote control system 10 includes one or more vehicles 100 as movable bodies, a remote control device 200 that generates a control command for the remote control of each vehicle 100 and that sends the control command to the vehicle 100, a plurality of distance measurement devices 300 that measures three-dimensional point cloud data about the vehicle 100, and a process management device 400 that manages the manufacturing process of the vehicle 100. In the first embodiment, the remote control device 200 is an example of the “control device” in the present disclosure.

It is preferable that the vehicle 100 be a battery electric vehicle (BEV). The movable body is not limited to the battery electric vehicle, and may be a gasoline vehicle, a hybrid electric vehicle, or a fuel cell electric vehicle, for example. The movable body is not limited to the vehicle 100, and may be an electric vertical takeoff and landing aircraft (a so-called flying vehicle), for example.

In the present disclosure, the “movable body” means a physical body that can move. The vehicle may be a vehicle that travels using wheels, or may be a vehicle that performs caterpillar traveling, and for example, is a passenger car, a track, a bus, a two-wheeled vehicle, a four-wheeled vehicle, a tank, a construction vehicle, or the like. In the case where the movable body is other than the vehicle, the expression “vehicle” and the expression “car” in the present disclosure can be replaced with “movable body” when appropriate, and the expression “traveling” can be replaced with “moving” when appropriate.

The vehicle 100 is configured to be capable of traveling by unmanned driving. The “unmanned driving” means a driving that does not depend on the traveling operation by an occupant. The traveling operation means an operation relevant to at least one of “running”, “turning”, and “stopping” of the vehicle 100. The unmanned driving is realized by an automatic or manual remote control that uses a device positioned in the exterior of the vehicle 100, or by an autonomous control of the vehicle 100. An occupant that does not perform the traveling operation may ride in the vehicle 100 that travels by unmanned driving. Examples of the occupant that does not perform the traveling operation include a person that merely sits on a seat of the vehicle 100, and a person that performs, in the vehicle 100, a work different from the traveling operation, as exemplified by attachment, inspection, or the operation of switches. The driving that depends on the traveling operation by the occupant is sometimes called “manned driving”.

In the present specification, the “remote control” is a “full remote control” in which all of actions of the vehicle 100 are fully determined from the exterior of the vehicle 100, and a “partial remote control” in which some of the actions of the vehicle 100 are determined from the exterior of the vehicle 100. Further, the “autonomous control” includes a “full autonomous control” in which the vehicle 100 autonomously controls its action without receiving information from the device in the exterior of the vehicle 100 at all, and a “partial autonomous control” in which the vehicle 100 autonomously controls its action using information received from the device in the exterior of the vehicle 100.

In the embodiment, the remote control of the vehicle 100 is executed in a factory where the vehicle 100 is manufactured. The factory includes a first place PL1 and a second place PL2. The first place PL1 is a place where the assembly of the vehicle 100 is executed, for example, and the second place PL2 is a place where the inspection of the vehicle 100 is executed, for example. The first place PL1 and the second place PL2 are connected by a traveling road SR along which the vehicle 100 can travel. An arbitrary position in the factory is expressed as x, y and z coordinate values in a reference coordinate system Σr.

A plurality of distance measurement devices 300 that adopts the vehicle 100 as the measurement object is installed in the periphery of the traveling road SR. The remote control device 200 can acquire the position and orientation of the vehicle 100 relative to a target route TR, in real time, using three-dimensional point cloud data measured by each distance measurement device 300. As the distance measurement device 300, a camera and a light detection and ranging (LiDAR) can be used. Particularly, the LiDAR is preferable because highly-accurate three-dimensional point cloud data is obtained. It is preferable that the plurality of distance measurement devices 300 be disposed such that two or more distance measurement devices 300 can always perform the measurement about the vehicle 100 when the vehicle 100 exists at an arbitrary position on the target route TR. Positions of the individual distance measurement devices 300 are fixed, and relative relations between the reference coordinate system Σr and device coordinate systems of the individual distance measurement devices 300 are previously known. Coordinate conversion matrixes for mutual conversion between coordinate values in the reference coordinate system Σr and coordinate values in the device coordinate systems of the individual distance measurement devices 300 are previously stored in the remote control device 200.

The remote control device 200 generates a control command for causing the vehicle 100 to travel along the target route TR, and sends the control command to the vehicle 100. The vehicle 100 travels in accordance with the received control command. Accordingly, in the remote control system 10, it is possible to move the vehicle 100 from the first place PL1 to the second place PL2, by remote control, without using a conveying device such as a crane or a conveyor.

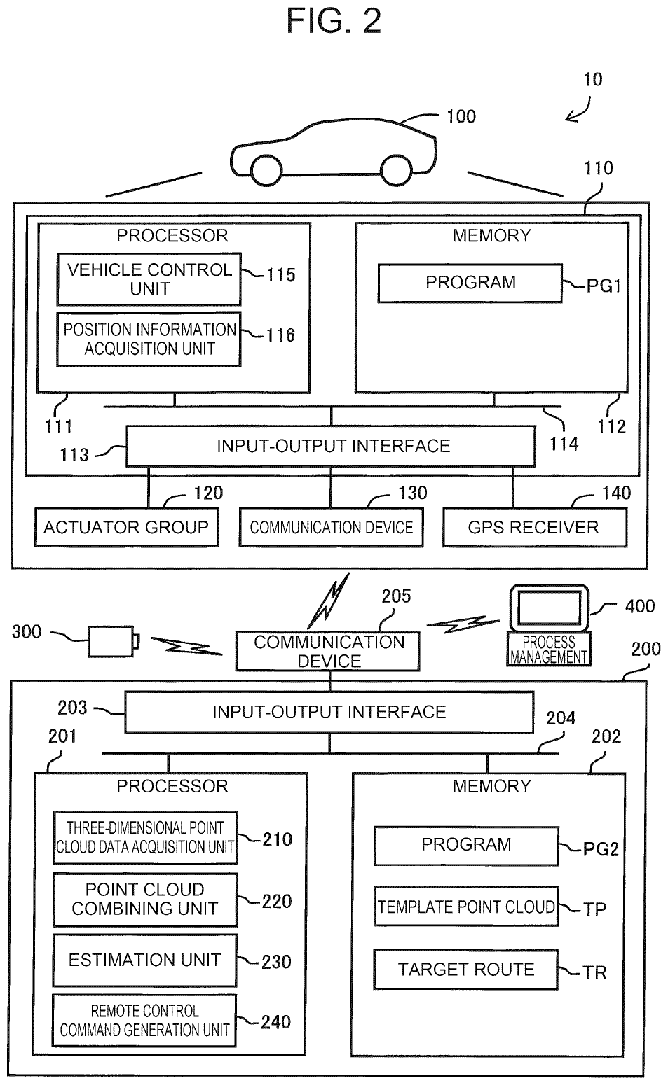

FIG. 2 is a block diagram showing the configuration of the vehicle 100 and the remote control device 200. The vehicle 100 includes a vehicle control device 110 for controlling parts of the vehicle 100, an actuator group 120 that is driven under the control by the vehicle control device 110, a communication device 130 for communicating with the remote control device 200 by wireless communication, and a GPS receiver 140 for acquiring position information about the vehicle 100. In the embodiment, the actuator group 120 includes an actuator of a driving device for accelerating the vehicle 100, an actuator of a steering device for changing the moving direction of the vehicle 100, and an actuator of a braking device for decelerating the vehicle 100. The driving device includes a battery, a traveling motor that is driven by the electric power of the battery, and driving wheels that are rotated by the traveling motor. The actuator of the driving device includes the traveling motor. The actuator group 120 may further include an actuator for swinging a windshield wiper of the vehicle 100, an actuator for opening and closing a power window of the vehicle 100, and the like.

The vehicle control device 110 is constituted by a computer including a processor 111, a memory 112, an input-output interface 113, and an internal bus 114. The processor 111, the memory 112, and the input-output interface 113 are connected through the internal bus 114, in a bi-directionally communicable manner. The input-output interface 113 is connected with the actuator group 120, the communication device 130, and the GPS receiver 140.

In the embodiment, the processor 111 functions as a vehicle control unit 115 and a position information acquisition unit 116, by executing a program PG1 that is previously stored in the memory 112. The vehicle control unit 115 controls the actuator group 120. When a driver rides in the vehicle 100, the vehicle control unit 115 can cause the vehicle 100 to travel, by controlling the actuator group 120 depending on the operation by the driver. In addition, regardless of whether the driver rides in the vehicle 100, the vehicle control unit 115 can cause the vehicle 100 to travel, by controlling the actuator group 120 depending on the control command that is sent from the remote control device 200. The position information acquisition unit 116 acquires the position information indicating the current place of the vehicle 100, using the GPS receiver 140. The position information acquisition unit 116 and the GPS receiver 140 may be excluded.

The remote control device 200 is constituted by a computer including a processor 201, a memory 202, an input-output interface 203, and an internal bus 204. The processor 201, the memory 202, and the input-output interface 203 are connected through the internal bus 204, in a bi-directionally communicable manner. The input-output interface 203 is connected with a communication device 205 for communicating with the vehicle 100, the distance measurement device 300, and the process management device 400, by wireless communication.

In the embodiment, the processor 201 functions as a three-dimensional point cloud data acquisition unit 210, a point cloud combining unit 220, an estimation unit 230, and a remote control command generation unit 240, by executing a program PG2 that is previously stored in the memory 202.

The three-dimensional point cloud data acquisition unit 210 acquires the three-dimensional point cloud data measured by the distance measurement device 300. The three-dimensional point cloud data is data that indicates the three-dimensional position of a point cloud detected by the distance measurement device 300.

The point cloud combining unit 220 selects two or more distance measurement devices 300 from the plurality of distance measurement devices 300 included in the remote control system 10, and creates combined point cloud data by combining two or more pieces of three-dimensional point cloud data that are obtained from the two or more distance measurement devices 300. As the combining method for a plurality of pieces of three-dimensional point cloud data, for example, one of the following methods can be employed.

### Combining Method M1 for Point Cloud

The coordinate values of the respective points in the three-dimensional point cloud data obtained by the respective distance measurement device 300 are converted from the device coordinate systems of the distance measurement devices 300 to a particular coordinate system such as the reference coordinate system Σr, and the coordinate values after the conversion are summed.

On this occasion, in the case where there is a plurality of points among which the difference in the coordinate value after the conversion is equal to or smaller than an allowable error, the plurality of points is replaced with one representative point. The coordinate values of the representative point is representative values such as average values of the coordinate values of the plurality of points.

### Combining Method M2 for Point Cloud

(a) First combined point cloud data is created by performing the position adjustment by matching for first three-dimensional point cloud data and second three-dimensional point cloud data, replacing corresponding points with one representative point, and adding points having no corresponding point with no change. The position coordinate of the representative point is a representative value such as an average value of the position coordinates of two corresponding points.

(b) Second combined point cloud data is created by performing the same processing as the processing (a) for the first combined point cloud data and third three-dimensional point cloud data.

Thereafter, by repeating the processing (b), an arbitrary number of pieces of three-dimensional point cloud data can be combined. For the position adjustment by matching, for example, an interactive closest point algorithm (ICP algorithm) can be used. In terms of the processing speed, the above-described combining method M1 is more preferable.

The estimation unit 230 estimates the position and orientation of the vehicle 100, using the combined point cloud data obtained by the point cloud combining unit 220 or a single piece of three-dimensional point cloud data obtained by a single distance measurement device 300. In the embodiment, the estimation unit 230 estimates the position and orientation of the vehicle 100, by executing template matching using a template point cloud TP stored in the memory 202. In the case where the three-dimensional point cloud data cannot be utilized, the estimation unit 230 can estimate the position and orientation of the vehicle 100, using a traveling history of the vehicle 100 and the position information detected by the GPS receiver 140 that is equipped in the vehicle 100. The estimation unit 230 may estimate only one of the position and orientation of the vehicle 100. In this case, the other of the position and orientation of the vehicle 100 is determined using the traveling history of the vehicle 100 or the like.

The information about the position and orientation of the vehicle is also referred to as “vehicle position information”. In the embodiment, the vehicle position information includes the position and orientation of the vehicle 100 in the reference coordinate system of the factory.

The remote control command generation unit 240 generates the control command for the remote control, using the estimated position and orientation of the vehicle 100, and sends the control command to the vehicle 100. The control command is a command for causing the vehicle 100 to travel along the target route TR stored in the memory 202. The control command can be generated as a command including a driving or braking power and a turning angle. Alternatively, the control command may be generated as a command including at least one of the position and orientation of the vehicle 100 and a route along which the vehicle 100 will travel.

In the embodiment, the control command includes the acceleration and steering angle of the vehicle 100, as parameters. In another embodiment, the control command may include the velocity of the vehicle 100 as a parameter, instead of or in addition to the acceleration of the vehicle 100.

The process management device 400 manages the whole of the manufacturing process of the vehicle 100 in the factory. For example, when one vehicle 100 starts the traveling along the target route TR, individual information indicating the identification number, type, and others of the vehicle 100 is sent from the process management device 400 to the remote control device 200. The position of the vehicle 100 that is detected by the remote control device 200 is sent also to the process management device 400. The function of the process management device 400 may be implemented in the same device as the remote control device 200.

The remote control device 200 is also referred to as “server”, and the distance measurement device 300 is also referred to as “external sensor”. Further, the control command is also referred to as “traveling control signal”, the target route TR is also referred to as “reference path”, and the reference coordinate system is also referred to as “global coordinate system”.

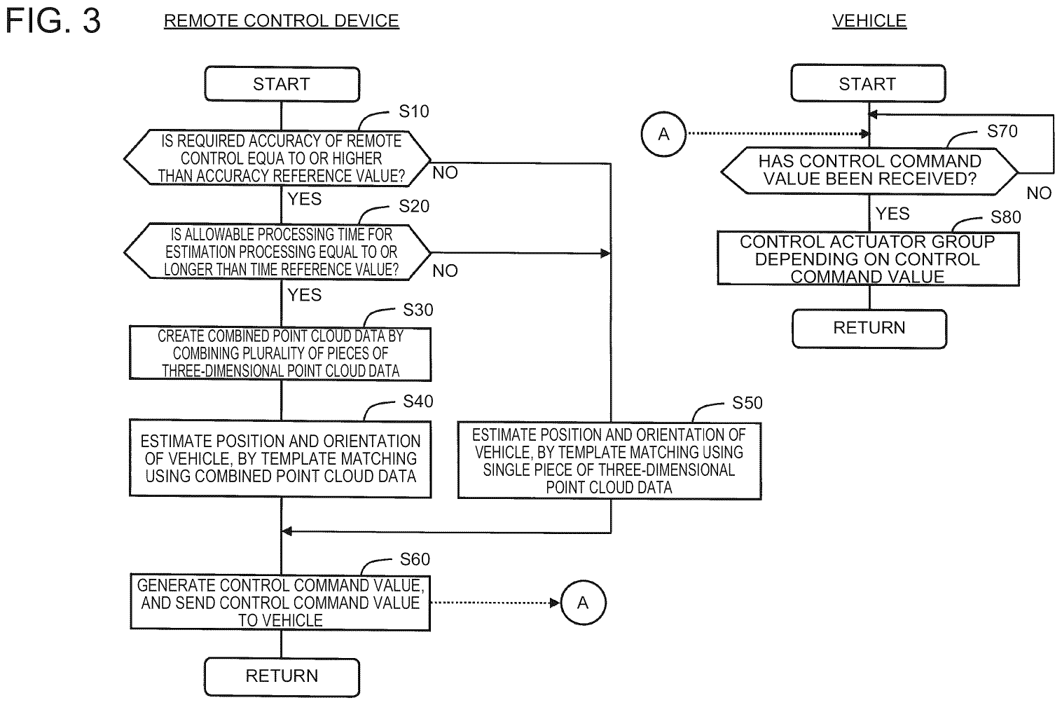

FIG. 3 is a flowchart showing a processing procedure of the remote control in the first embodiment. The processing by the remote control device 200 is executed in a constant cycle. Alternatively, the processing by the remote control device 200 that is shown in FIG. 3 may be executed whenever the three-dimensional point cloud data acquisition unit 210 newly acquires the three-dimensional point cloud data from the plurality of distance measurement devices 300 that performs the measurement about the vehicle 100 as the control object. The three-dimensional point cloud data acquisition unit 210 may execute preprocessing of removing background point cloud data indicating a stationary object, from the newly acquired three-dimensional point cloud data.

In step S10, the point cloud combining unit 220 determines whether the required accuracy of the remote control by the remote control device 200 is equal to or higher than an accuracy reference value. For example, the required accuracy of the remote control is previously set for each of a plurality of sections that is provided along the target route TR. Further, the required accuracy may be set depending on the traveling situation of the vehicle 100. The position of the vehicle 100 when the required accuracy is decided may be a position that was estimated in the last estimation process, or may be a position that is estimated from the traveling history of the vehicle 100. The accuracy reference value may be a previously set threshold, or the accuracy reference value may be altered depending on the traveling situation of the vehicle 100.

When it is determined that required accuracy is lower than the accuracy reference value, the proceeding proceeds to step S50, and the estimation unit 230 selects one distance measurement device 300 from the plurality of distance measurement devices 300, and executes an estimation process (a second estimation process) of estimating the position and orientation of the vehicle 100 using a single piece of three-dimensional point cloud data obtained by the selected distance measurement device 300. This estimation process can be executed by performing matching between the three-dimensional point cloud data and the template point cloud TP.

On the other hand, when it is determined that the required accuracy is equal to or higher than the accuracy reference value, the process proceeds to step S20, and the point cloud combining unit 220 determines whether an allowable processing time for the estimation process for the position and orientation of the vehicle 100 is equal to or longer than a time reference value. The allowable processing time is set to a time during which failure does not occur in the remote control even when the processing time for the estimation process is long. For example, the allowable processing time is previously set for each of a plurality of sections that is provided along the target route TR. Further, the allowable processing time may be set depending on the traveling situation of the vehicle 100. When the processing time for the estimation process can be sufficiently secured, for example, before the start of the remote control, during the temporary stop of the vehicle 100, or during the low-velocity traveling of the vehicle 100, the allowable processing time is set to a long time. The time reference value may be a previously set threshold, or the time reference value may be altered depending on the traveling situation of the vehicle 100.

When it is determined that the allowable processing time is shorter than the time reference value, the process proceeds to the above-described step S50, and the position and orientation of the vehicle 100 are estimated using a single piece of three-dimensional point cloud data.

On the other hand, when it is determined that the allowable processing time is equal to or longer than the time reference value, the process proceeds to step S30. In step S30, the point cloud combining unit 220 selects two or more distance measurement devices 300 from the plurality of distance measurement devices 300 included in the remote control system 10, and creates the combined point cloud data by combining two or more pieces of three-dimensional point cloud data that are obtained from the two or more distance measurement devices 300. In step S40, the estimation unit 230 estimates the position and orientation of the vehicle 100, by executing matching between the combined point cloud data and the template point cloud TP (a first estimating process).

In step S60, the remote control command generation unit 240 generates a control command value, using the position and orientation of the vehicle 100 that are estimated in step S40 or step S50, and sends the control command value to the vehicle 100. Details of step S60 will be described below.

In step S60, first, the remote control command generation unit 240 determines a target position to which the vehicle 100 will go from now, using the vehicle position information including the position and orientation of the vehicle 100 and the target route TR. The remote control command generation unit 240 determines the target position on the target route TR ahead of the current place of the vehicle 100, and generates the control command value for causing the vehicle 100 to travels toward the target position. In the embodiment, the control command value includes the acceleration and steering angle of the vehicle 100, as parameters. The remote control command generation unit 240 calculates the traveling velocity of the vehicle 100, from the transition of the position of the vehicle 100, and compares the calculated traveling velocity and a target velocity. As a whole, the remote control command generation unit 240 determines the acceleration such that the vehicle 100 is accelerated, when the traveling velocity is lower than the target velocity, and determines the acceleration such that the vehicle 100 is decelerated, when the traveling velocity is higher than the target velocity. Further, the remote control command generation unit 240 determines the steering angle and the acceleration such that the vehicle 100 does not depart from the target route TR, when the vehicle 100 is positioned on the target route TR, and determines the steering angle and the acceleration such that the vehicle 100 returns to the target route TR, when the vehicle 100 is not positioned on the target route TR, in other words, when the vehicle 100 has departed from the target route TR. In another embodiment, the control command value may include the velocity of the vehicle 100 as a parameter, instead of or in addition to the acceleration of the vehicle 100. The control command value generated in this way is sent from the remote control device 200 to the vehicle 100.

The control process by the processor 111 of the vehicle 100 includes step S70 and step S80. In step S70, the vehicle control unit 115 waits until the control command value is acquired from the remote control device 200. When the control command value is acquired, the process proceeds to step S80, and the vehicle control unit 115 controls the actuator group 120 depending on the acquired control command value. In the remote control system 10 in the embodiment, it is possible to cause the vehicle 100 to travel by remote control, and to move the vehicle 100 along the target route TR without using conveying equipment such as a crane or a conveyor.

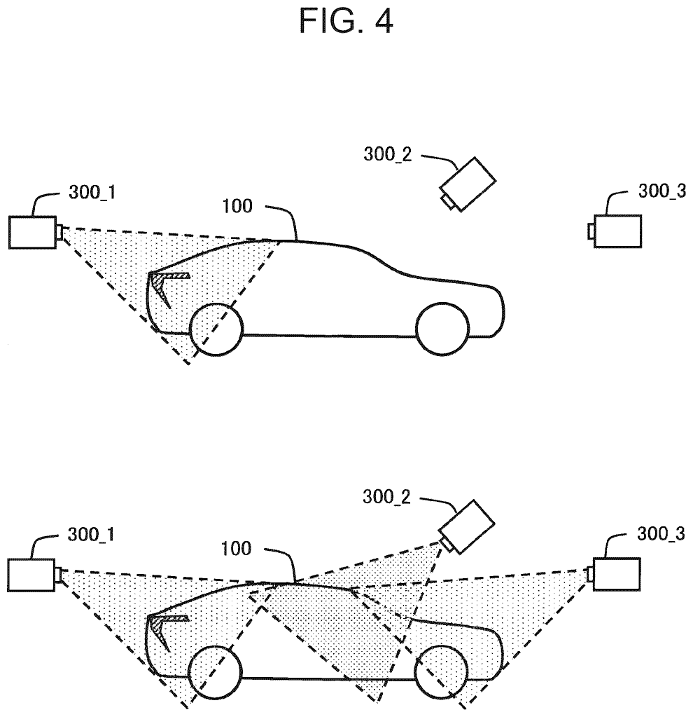

FIG. 4 is an explanatory diagram showing an example of alternation of the number of pieces of three-dimensional point cloud data that are used. In an example shown at an upper portion in FIG. 4, when the required accuracy of the remote control is lower than the accuracy reference value, only a single piece of three-dimensional point cloud data that is obtained by one distance measurement device 300_1 is used for the estimation process. As the single piece of three-dimensional point cloud data that is used for the estimation process, for example, three-dimensional point cloud data in which the number of points is largest is selected. Alternatively, it is allowable to select three-dimensional point cloud data obtained by one distance measurement device 300 that is presumed to be installed at the optimal position for the estimation process, from the traveling history of the vehicle 100.

In an example at a lower portion in FIG. 4, when the required accuracy of the remote control is equal to or higher than the accuracy reference value, three pieces of three-dimensional point cloud data that are obtained by three distance measurement devices 300_1, 300_2, 300_3 are used for the estimation process. In this case, the three pieces of three-dimensional point cloud data are combined, and the combined point cloud data is created. For example, the two or more pieces of three-dimensional point cloud data that are used for the estimation process are selected in the order from the three-dimensional point cloud data in which the number of points is largest. Alternatively, it is allowable to select two or more pieces of three-dimensional point cloud data obtained by two or more distance measurement devices 300 that are presumed to be installed at optimal positions for the estimation process, from the traveling history of the vehicle 100. The two or more distance measurement devices 300 that are used for the estimation process preferably should include distance measurement devices 300 that observe the vehicle 100 from different directions, and particularly, preferably should include at least two distance measurement devices 300 that observe the vehicle 100 from the forward side and rearward side of the vehicle 100 respectively.

The number of pieces of three-dimensional point cloud data that are used for the estimation process preferably should be set so as to be larger as the required accuracy of the remote control is higher. Further, the number of pieces of three-dimensional point cloud data that are used for the estimation process preferably should be set so as to be larger as the allowable processing time for the estimation process is longer.

The estimation unit 230 in the embodiment executes the estimation process using the combined point cloud data, when the required accuracy of the remote control is equal to or higher than the accuracy reference value. Thereby, it is possible to enhance the estimation accuracy, when the required accuracy of the remote control is high.

Further, the estimation unit 230 executes the estimation process using the combined point cloud data, when the allowable processing time for the estimation process is equal to or longer than the time reference value. Thereby, it is possible to enhance the estimation accuracy, when the allowable processing time for the estimation process is long. Furthermore, the estimation unit 230 executes the estimation process using a single piece of three-dimensional point cloud data, when the allowable processing time is shorter than the time reference value. Thereby, it is possible to enhance the processing speed, when the allowable processing time for the estimation process is short. One of the above-described steps S10 and S20 may be skipped.

It is preferable that the required accuracy of the remote control and the allowable processing time for the estimation process be altered depending on the traveling situation of the vehicle 100. The traveling situation in this case means the position and velocity of the vehicle 100 on the target route TR.

As described above, in the first embodiment, the combined point cloud data is created by combining two or more pieces of three-dimensional point cloud data, and at least one of the position and orientation of the vehicle 100 is estimated using the combined point cloud data. Therefore, it is possible to enhance the estimation accuracy for the position and orientation of the movable body. Further, at least one of the position and orientation of the vehicle 100 is estimated by selecting one of the estimation process using the combined point cloud data resulting from combining two or more pieces of three-dimensional point cloud data and the estimation process using a single piece of three-dimensional point cloud data, depending on the traveling situation of the vehicle 100. Therefore, it is possible to give priority to one of the estimation accuracy and the processing speed, depending on the traveling situation.

In the embodiment, as the traveling situation of the vehicle 100, the position and velocity of the vehicle 100 on the target route TR are used, but the traveling situation of the vehicle 100 may be specified by factors other than the position and velocity of the vehicle 100. For example, the orientation and turning angle of the vehicle 100 may be used as the traveling situation.

In the above embodiment, the vehicle 100 only needs to have a configuration in which the vehicle 100 can move by remote control, and for example, may have a platform including a configuration described below. Specifically, the vehicle 100 only needs to include at least the vehicle control unit 115 and the communication device 130, for exerting the three functions of “running”, “turning”, and “stopping” by remote control. That is, the vehicle 100 that can move by remote control does not need to be provided with a driver's seat and at least some of interior components such as a dashboard, does not need to be provided with at least some of exterior components such as a bumper and a fender, and does not need to be provided with a bodyshell. In this case, the other components such as the bodyshell may be attached to the vehicle 100 before the vehicle 100 is shipped from the factory, or the other components such as the bodyshell may be attached to the vehicle 100 after the vehicle 100 is shipped from the factory in a state where the other components such as the bodyshell have not been attached to the vehicle 100. Also in the case of the platform, the position determination can be performed similarly to the vehicle 100 in the embodiments.

### B. Second Embodiment

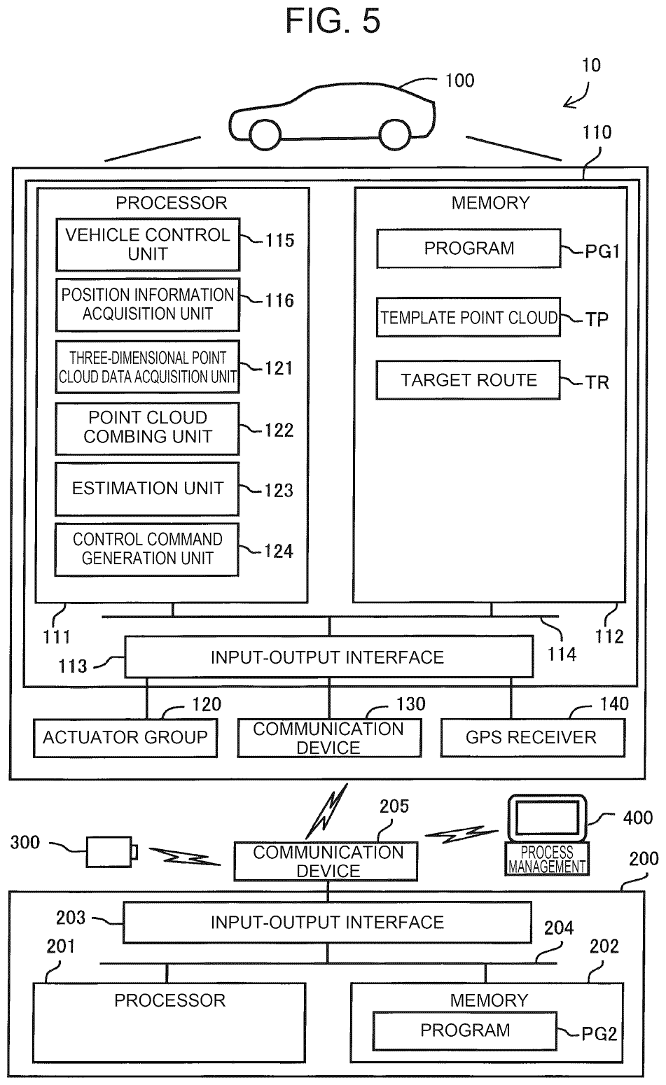

FIG. 5 is a block diagram showing the configuration of a vehicle 100 and a remote control device 200 in a second embodiment. Differences from the configuration shown in FIG. 2 in the first embodiment are mainly the following three points.

(1) Functions of a three-dimensional point cloud data acquisition unit 121, a point cloud combining unit 122, an estimation unit 123, and a control command generation unit 124 are added to the function of the processor 111 of the vehicle 100.

(2) The template point cloud TP and the target route TR are stored in the memory 112 of the vehicle 100.

(3) Functions of the three-dimensional point cloud data acquisition unit 210, the point cloud combining unit 220, the estimation unit 230, and the remote control command generation unit 240 are excluded from the function of the processor 201 of the remote control device 200.

The functions of the three-dimensional point cloud data acquisition unit 121, the point cloud combining unit 122, the estimation unit 123, and the control command generation unit 124 are almost the same as the functions of the three-dimensional point cloud data acquisition unit 210, the point cloud combining unit 220, the estimation unit 230, and the remote control command generation unit 240, respectively, and therefore the description thereof is omitted.

In the second embodiment, the process of creating the combined point cloud data by combining two or more pieces of three-dimensional point cloud data and estimating at least one of the position and orientation of the vehicle 100 using the combined point cloud data is executed by the vehicle 100. That is, in the second embodiment, the vehicle control device 110 of the vehicle 100 corresponds to the “control device” in the present disclosure.

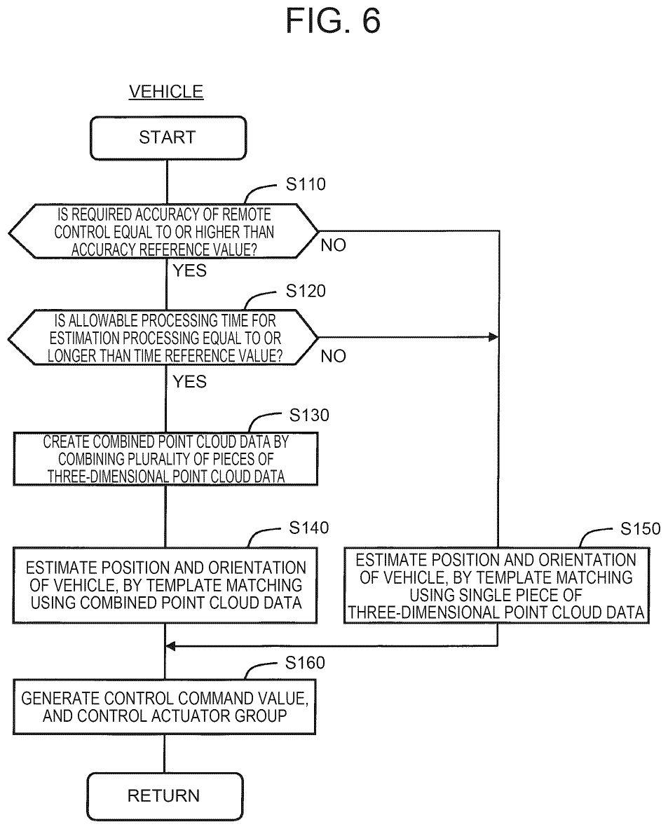

FIG. 6 is a flowchart showing a processing procedure of a vehicle control in the second embodiment. Steps S110 to S160 in FIG. 6 correspond to steps S10 to S60 shown in FIG. 3 in the first embodiment, respectively. In step S160, the control command value is created by the control command generation unit 124 of the vehicle 100, and therefore the control of the actuator group 120 of the vehicle 100 is executed without the sending and receiving of the control command value between the remote control device 200 and the vehicle 100.

The template point cloud TP and the target route TR are stored in the memory 112 of the vehicle 100, before the vehicle 100 starts the traveling along the target route TR. The template point cloud TP and the target route TR may be supplied from the remote control device 200 or the process management device 400, or may be written in the memory 112 of the vehicle 100 using other means.

As described above, in the second embodiment, similarly to the first embodiment, the combined point cloud data is created by combining two or more pieces of three-dimensional point cloud data, and at least one of the position and orientation of the movable body is estimated using the combined point cloud data. Therefore, it is possible to enhance the estimation accuracy for the position and orientation of the movable body. Further, at least one of the position and orientation of the vehicle 100 is estimated by selecting one of the estimation process using the combined point cloud data resulting from combining two or more pieces of three-dimensional point cloud data and the estimation process using a single piece of three-dimensional point cloud data, depending on the traveling situation of the vehicle 100. Therefore, it is possible to give priority to one of the estimation accuracy and the processing speed, depending on the traveling situation.

### C. Other Embodiment

In embodiments described below, “server 200” means the remote control device 200, and “external sensor” means the distance measurement device 300. Further, “traveling control signal” means the control command, “reference path” means the target route TR, and “global coordinate system” means the reference coordinate system Σr.

(C1) In the above embodiments, the external sensor is a light detection and ranging (LiDAR). However, the external sensor does not need to be a LiDAR, and may be a camera, for example. In the case where the external sensor is a camera, the server 200 acquires the position of the vehicle 100, for example, by detecting the external form of the vehicle 100 from a pickup image, calculating the coordinates of a position measurement point of the vehicle 100 in a coordinate system for the pickup image, that is, in a local coordinate system, and converting the calculated coordinates into coordinates in the global coordinate system. For example, the external form of the vehicle 100 included in the pickup image can be detected by inputting the pickup image to a detection model for which an artificial model is used. For example, the detection model is prepared in the interior of the system 10 or in the exterior of the system 10, and is previously stored in the memory of the server 200. Examples of the detection model include a machine learning model for which learning have been performed such that one of semantic segmentation and instance segmentation is realized. As the machine learning model, for example, a convolutional neural network (referred to as a CNN, hereinafter) for which learning has been performed by a supervised learning using a learning data set can be used. For example, the learning data set includes a plurality of training images that includes the vehicle 100, and labels that indicate whether each region in the training image is a region for the vehicle 100 or a region other than the vehicle 100. At the time of the learning for the CNN, it is preferable to update parameters in the CNN so as to reduce the error between the output result by the detection model and the label, by a back propagation method. Further, for example, the server 200 can acquire the orientation of the vehicle 100, by performing the estimation based on the orientation of the mobile vector of the vehicle 100 that is calculated from the position change in the characteristic point of the vehicle 100 among frames of the pickup image, using an optical flow method.

(C2) In the above first embodiment, the processing from the acquisition of the vehicle position information including the position and orientation of the vehicle 100 to the generation of the traveling control signal is executed by the server 200. However, at least a part of the processing from the acquisition of the vehicle position information to the generation of the traveling control signal may be executed by the vehicle 100. For example, the following modes (1) to (3) may be adopted.

(1) The server 200 may acquire the vehicle position information, may determine the target position to which the vehicle 100 will go from now, and may generate a path from the current place of the vehicle 100 that is shown in the acquired vehicle position information to the target position. The server 200 may generate a path to a target position between the current place and a destination, or may generate a path to the destination. The server 200 may send the generated path to the vehicle 100. The vehicle 100 may generate the traveling control signal such that the vehicle 100 travels on the path received from the server 200, and may control the actuator of the vehicle 100 using the generated traveling control signal.

(2) The server 200 may acquire the vehicle position information, and may send the acquired vehicle position information to the vehicle 100. The vehicle 100 may determine the target position to which the vehicle 100 will go from now, may generate the path from the current place of the vehicle 100 that is shown in the received vehicle position information to the target position, may generate the traveling control signal such that the vehicle 100 travels on the generated path, and may control the actuator of the vehicle 100 using the generated traveling control signal.

(3) In the above modes (1) and (2), an internal sensor may be equipped in the vehicle 100, and the detection result output from the internal sensor may be used for at least one of the generation of the path and the generation of the traveling control signal. The internal sensor is a sensor that is equipped in the vehicle 100. Specifically, for example, the internal sensor can include a camera, a LiDAR, a millimeter-wave radar, an ultrasonic sensor, a GPS sensor, an acceleration sensor, a gyroscope sensor, and the like. For example, in the above mode (1), the server 200 may acquire the detection result of the internal sensor, and may reflect the detection result of the internal sensor in the path at the time of the generation of the path. In the above mode (1), the vehicle 100 may acquire the detection result of the internal sensor, and may reflect the detection result of the internal sensor in the traveling control signal at the time of the generation of the traveling control signal. In the above mode (2), the vehicle 100 may acquire the detection result of the internal sensor, and may reflect the detection result of the internal sensor in the path at the time of the generation of the path. In the above mode (2), the vehicle 100 may acquire the detection result of the internal sensor, and may reflect the detection result of the internal sensor in the traveling control signal at the time of the generation of the traveling control signal.

(C3) In the above embodiments, the internal sensor may be equipped in the vehicle 100, and the detection result output from the internal sensor may be used for at least one of the generation of the path and the generation of the traveling control signal. For example, the vehicle 100 may acquire the detection result of the internal sensor, and may reflect the detection result of the internal sensor in the path at the time of the generation of the path. The vehicle 100 may acquire the detection result of the internal sensor, and may reflect the detection result of the internal sensor in the traveling control signal at the time of the generation of the traveling control signal.

(C4) In the first embodiment, the server 200 automatically generates the traveling control signal that is sent to the vehicle 100. However, the server 200 may generate the traveling control signal that is sent to the vehicle 100, in accordance with the operation by an external operator in the exterior of the vehicle 100. For example, the external operator may operate a maneuvering device including a display device that displays the pickup image output from the external sensor, a steering wheel, accelerator pedal and brake pedal for remotely operating the vehicle 100, and a communication device for communicating with the server 200 by wired communication or wireless communication, and the server 200 may generate the traveling control signal depending on the operation to the maneuvering device.

(C5) In the above embodiments, the vehicle 100 only needs to have a configuration in which the vehicle 100 can move by unmanned driving, and for example, may have a platform that has a configuration described below. Specifically, the vehicle 100 only needs to include at least a control device that controls the traveling of the vehicle 100 and the actuator of the vehicle 100, for exerting the three functions of “running”, “turning”, and “stopping” by unmanned driving. In the case where the vehicle 100 acquires information from the exterior for unmanned driving, the vehicle 100 only needs to further include the communication device. That is, the vehicle 100 that can move by unmanned driving does not need to be provided with a driver's seat and at least some of interior components such as a dashboard, does not need to be provided with at least some of exterior components such as a bumper and a fender, and does not need to be provided with a bodyshell. In this case, the other components such as the bodyshell may be attached to the vehicle 100 before the vehicle 100 is shipped from the factory, or the other components such as the bodyshell may be attached to the vehicle 100 after the vehicle 100 is shipped from the factory in a state where the other components such as the bodyshell have not been attached to the vehicle 100. Components may be attached from arbitrary directions such as the upper side, lower side, front side, rear side, right side and left side of the vehicle 100, and may be attached from the same direction as each other, or may be attached from different directions from each other. Also in the case of the platform, the position determination can be performed similarly to the vehicle 100 in the first embodiment.

(C6) The vehicle 100 may be manufactured by combining a plurality of modules. The module means a unit constituted by a plurality of components that is collected depending on a site or function of the vehicle 100. For example, the platform of the vehicle 100 may be manufactured by combining a front module configuring a front portion of the platform, a central module configuring a central portion of the platform, and a rear module configuring a rear portion of the platform. The number of modules that constitute the platform is not limited to three, and may be two or less or may be four or more. Further, components constituting a portion of the vehicle 100 that is different from the platform may be modularized in addition to or instead of components constituting the platform. Further, each module may include arbitrary exterior components such as bumper and a grill, and arbitrary interior components such as a seat and a console. Further, without being limited to the vehicle 100, an arbitrary kind of movable body may be manufactured by combining a plurality of modules. For example, such a module may be manufactured by joining a plurality of components by welding, a fixture or the like, or may be manufactured by integrally molding at least some of components constituting the module, as one component, by casting. The molding technique of integrally molding one component, particularly a relatively large component is also called giga cast or mega cast. For example, the above front module, the above central module, and the above rear module may be manufactured by the giga cast.

(C7) The conveyance of the vehicle 100 using the traveling of the vehicle 100 by unmanned driving is also called “self-traveling conveyance”. Further, the configuration for realizing the self-traveling conveyance is also called “vehicle remote-control autonomous-traveling conveyance system”. Further, the production method of producing the vehicle 100 using the self-traveling conveyance is also called “self-traveling production”. In the self-traveling production, at least a part of the conveyance of the vehicle 100 is realized by self-traveling conveyance, in a factory where the vehicle 100 is manufactured, for example.

The present disclosure is not limited to the above-described embodiments, and can be realized as various configurations without departing from the spirit of the present disclosure. For example, technical characteristics in the embodiments that correspond to technical characteristics in the modes described in SUMMARY can be replaced or combined when appropriate, for solving some or all of the above-described problems or for achieving some or all of the above-described effects. Further, the technical characteristics can be removed when appropriate, except technical characteristics that are described to be essential in the present specification.

What is claimed is:

1. A control device configured to generate a control command for controlling a movable body, using measurement results of a plurality of distance measurement devices, the control device comprising:
a point cloud combining unit configured to create combined point cloud data by combining two or more pieces of three-dimensional point cloud data that are obtained by two or more distance measurement devices of the plurality of distance measurement devices; and
an estimation unit configured to execute a first estimation process of estimating at least one of a position and orientation of the movable body, using the combined point cloud data.

2. The control device according to claim 1, wherein the estimation unit is configured to execute the first estimation process, when an allowable processing time for the first estimation process is equal to or longer than a time reference value.

3. The control device according to claim 2, wherein the estimation unit is configured to execute a second estimation process of estimating at least one of the position and orientation of the movable body, using a single piece of the three-dimensional point cloud data, when the allowable processing time is shorter than the time reference value.

4. The control device according to claim 1, wherein the estimation unit is configured to execute the first estimation process, when a required accuracy of the control of the movable body is equal to or higher than an accuracy reference value.

5. The control device according to claim 1, wherein the estimation unit is configured to select and execute one of the first estimation process and a second estimation process of estimating at least one of the position and orientation of the movable body, using a single piece of the three-dimensional point cloud data, depending on a traveling situation of the movable body.
